(19) United States
(12) Patent Application Publication
(10) Pub. No.: US 2022/0011685 A1
(43) Pub. Date: Jan. 13, 2022

(54) TONER FOR DEVELOPING AN ELECTROSTATIC CHARGE IMAGE AND AN IMAGE FORMING METHOD

(71) Applicant: Konica Minolta, Inc., Tokyo (JP)

(72) Inventors: Yuya KUBO, Tokyo (JP); Takanari KAYAMORI, Kanagawa (JP); Noboru UEDA, Tokyo (JP)

(21) Appl. No.: 17/371,228

(22) Filed: Jul. 9, 2021

(30) Foreign Application Priority Data
Jul. 13, 2020 (JP) 2020-120021

(51) Int. Cl. G03G 9/087; G03G 9/09; G03G 9/097; G03G 15/20

(52) U.S. Cl. CPC G03G 9/08755; G03G 9/08711; G03G 9/0918; G03G 15/20; G03G 9/0904; G03G 9/09708; G03G 9/0914

(57) ABSTRACT

The toner for developing an electrostatic charge image of the present invention contains a toner base particle comprising a binder resin, at least two kinds of organic pigments and carbon black, and strontium titanate as an external additive.

### CROSS REFERENCE TO RELATED APPLICATIONS

The entire disclosure of Japanese Patent Application No. 2020-120021 filed on Jul. 13, 2020, is incorporated herein by reference in its entirety.

### BACKGROUND

### Technological Field

The present invention relates to a toner for developing an electrostatic charge image and an image forming method.

### Description of Related Art

Toners are known in which a plurality of kinds of organic pigments are internally added into one toner base particle. The addition of the plurality of kinds of organic pigments enables adjustment or enlargement of absorbing wavelength range, thereby realizes an image formed by the toner to have a color tone within a desired color range.

JP-A-5-027481 describes a toner containing at least three pigment from a phthalocyanine-based blue pigment, a disazo-type yellow pigment, an azo-type red pigment and a quinacridone-based red pigment, and a specific perylene-based compound, can enhance blackness of a formed image without using carbon black.

### SUMMARY

According to the findings of the present inventors, a toner containing a plurality of kinds of organic pigments, like the toner as described in JP-A-5-027481, has insufficient chargeability or insufficient cleanability after image formation.

In view of the above problems, it is an object of the present invention to provide a toner in which while a plurality of kinds of organic pigments are internally added into one toner base particle, the toner has a higher chargeability and a cleanability, and an image forming method using the toner.

In order to realize the above object, a toner for developing an electrostatic charge image reflecting one aspect of the present invention has toner base particles and an external additive. The toner base particles include a binder resin, at least two kinds of organic pigments and carbon black, and the external additive includes strontium titanate.

### BRIEF DESCRIPTION OF DRAWINGS

The advantageous and features provided by one or mom embodiments of the invention will become more fully understood from the detailed description given hereinbelow and the appended drawing which are given by way of illustration only, and thus are not intended as a definition of the limits of the present invention:

FIG. 1 is a schematic configuration diagram illustrating an example of an image forming apparatus relating to the present embodiment;

### DETAILED DESCRIPTION OF EMBODIMENTS

Hereinafter, one or more embodiments of the present invention will be described with reference to the drawing. However, the scope of the invention is not limited to the disclosed embodiments.

1. Toner for Developing Electrostatic Charge Image

One embodiment of the present invention relates to a toner for developing an electrostatic charge image (electrostatic latent image) formed on an image carrier such as a photoreceptor. The above toner may be a one component developer or a two components developer containing carrier particles and toner particles.

The toner has toner base particles and an external additive adhering to the surface of the toner base particles. The toner base particles contain a binder resin and at least two kinds of organic pigments. The external additive contains strontium titanate.

According to the findings of the present inventors, when a toner contains two or more kinds of organic pigments, the total amount of the organic pigment in one toner base particles tends to become large, accompanied with the increase in the type of organic pigment. In addition, when because organic pigments have a large resistance increases, the charging property of the toner becomes unstable as the amount of the organic pigments becomes large. Then, because of the unstable charging property, the developability of the toner at the early stage of continuous image forming may be insufficient, resulting in an insufficient image density. In addition, the unstable charging property may result in a scattering of toners which are not deposited on an image carrier inside an image forming apparatus, which causes adverse effects to the image forming apparatus.

In contrast, in the present embodiment the toner base particles contain carbon black. Because of the high electrification property of carbon black, the charging property of the toner is stabilized, and the scattering of toners which are not deposited on an image carrier is suppressed.

In addition, strontium titanate contained as an external additive in the above toner has a lower resistance compared with other substances (for example, silica, and the like) used as an external additive. Thus, strontium titanate acts as a resistance adjusting agent in the above toner, by which excessive charging of the toner, occurred as a result of increment of electric resistance due to the increment of the amount of the pigments, can be suppressed. Because the strontium titanate as an external additive is attached to an outer surface of the toner base particles, its property as the resistance adjusting agent can be exhibited from the early stage of image forming, as compared to ordinary resistance adjusting agent contained inside the toner base particles. Because of these effects of strontium titanate, the charging property of the toner is further stabilized, and the scattering of toners which are not deposited on an image carrier is further suppressed.

As described above, stabilization of the chargeability by strontium titanate can exhibit its efficacy from the early stage of image forming. On the other hand, when the image formation is repeated over a long period of time, strontium titanate as an external additive may be desorbed from the toners which do not adhere to the image carrier and repeatedly flow, and thus stabilization of the charging property by strontium titanate may not be maintained during long-term use. Contrary to the above, in the present embodiment, long-term stabilization of the charging property can also be ensured by carbon black internally added to the toner base particles. In other words, both of strontium titanate and carbon black stabilize the charging property of the toner particles, and the effect due to strontium titanate as an external additive is particularly remarkable at the early stage of continuous printing, and the effect due to carbon black is particularly remarkable in long-term maintenance of the stabilization of the charging property.

Hereinafter, the toner of the present invention based on the above technical concept will be described in more detail.

1-1. Toner Base Particles

The toner base particles have a binder resin, two or more kinds of organic pigments, and a carbon black.

The toner base particles preferably have an average particle diameter on a volume basis of 3.0 μm or more and 10.0 μm or less, more preferably 5.0 μm or more and 8.0 μm or less, and still more preferably 5.5 μm or more and 7.0 μm or less. By setting the average particle diameter on a volume basis of the toner base particles to 5.0 μm or more, the two or more kinds of pigments can be sufficiently internally added to the toner base particles thereby a good color developability can be obtained, and transfer efficiency of the toner can be increased. By setting the average particle diameter on a volume basis of the toner base particles to 8.0 μm or less, the resolution of the image to be formed can be further increased.

The average particle diameter on a volume basis of the toner base particles can be measured using a measuring device in which a computer system equipped with a soft Software V3.51 for data processing is connected to a particle size distribution measuring device (manufactured by Beckman Coulter Co., Ltd., Coulter Multisizer 3). Specifically, 0.02 g of a sample (toner base particles) is added to 20 mL of a surfactant solution (a surfactant solution for dispersing toner particles, obtained by diluting, for example, a neutral detergent containing a surfactant component 10 times with pure water) and adapted, and then subjected to an ultrasonic dispersion treatment for 1 minutes to prepare a dispersion of toner base particles. The dispersion is pipetted into a beaker containing an electrolyte (Beckman Coulter, ISOTONII) in the sample stand until the indicated density of the measuring device is 8% By setting this concentration, reproducible measurement values can be obtained. Then, in the measuring device, the number of measured particle counts is set to 25000 and the aperture diameter is set to 100 μm, and a measurement range of 2 to 60 μm is divided into 256 to calculate each frequency value, and based on this, an average particle diameter on a volume basis is calculated.

1-1-1. Binder Resin

The binder resin is preferably a thermoplastic resin.

Examples of the thermoplastic resins include styrene resins, vinyl resins (such as acrylic resins and styrene-acrylic resins), polyester resins, silicone resins, olefin resins, polyamide resins, and epoxy resins.

The binder resin may be an amorphous resin or a crystalline resin. Or, the binder resin may be a complex resin of a hybrid of an amorphous resin and a crystalline resin.

(Amorphous Resin)

In this specification, an amorphous resin means a resin in which a melting point is not observed in measurement by differential scanning calorimetry (DSC: Differential Scanning Calorimetry). In this specification, when a melting point is observed in a resin, it means that a peak in which a half width of an endothermic peak is within 15° C. is observed when measured at a temperature rise rate of 10° C./min in DSC.

When the glass transition temperature observed in the first temperature rise process in DSC measurement is set as a Tg₁ and the glass transition temperature observed in the second temperature rise process is set as a Tg₂, the amorphous resin preferably has a Tg₁ of 35° C. or more and 80° C. or less, and more preferably 45° C. or more and 65° C. or less. In addition, the amorphous resin preferably has a Tg₂ of 20° C. or more and 70° C. or less, more preferably 30° C. or more and 55° C. or less. When Tg₁ of the amorphous resin is 35° C. or more or Tg₂ is 20° C. or more, heat resistance (heat-resistant storage property, and the like) of the toner can be further increased. When Tg₁ of the amorphous resin is 80° C. or less or Tg₂ is 70° C. or less, low-temperature fixability of the toner can be further increased.

In this specification, the glass transition temperature (Tg) of the resin can be a value measured using a known DSC measuring machine (for example. Diamond DSC manufactured by Perkin Elmer Co., Ltd.). Specifically, 3.0 mg of the measurement sample (resin) is enclosed in an aluminum pan and set in a sample holder of a DSC measuring machine. Use empty aluminum bread for reference. Then, by the measurement conditions (heating and cooling conditions) of: a first heating process of raising the temperature from 0° C. at a heating rate of 10° C./min until 200° C.; a cooling process of cooling from 200° C. at a cooling rate of 10° C./min until 0° C.; and a second heating process of raising the temperature from 0° C. at a heating rate of 10° C./min until 200° C., are conducted through this order to obtain DSC curves. Based on the obtained DSC curves, an extension line of the baseline prior to the rise of the first endothermic peak in the respective temperature rise process and a tangent line indicating a maximum slope between the rising portion of the first peak and the peak apex are drawn, and the intersection point thereof is defined as the glass transition temperature (Tg₁ and Tg₂).

The content of the amorphous resin is preferably 20% by mass or more and 99% by mass or less, more preferably 30% by mass or more and 95% by mass or less, and still more preferably 40% by mass or more and 90% by mass or less, based on the total mass of the toner base particles. When the content of the amorphous resin is 20% by mass or more, the intensity of the image to be formed can be further increased.

Examples of the amorphous resins include styrene resins, vinyl resins, olefin resins, epoxy resins, amorphous polyester resins, polyurethane resins, polyamide resins, cellulose resins, and polyether resins. One kind of these resins may be used alone, or two or more kinds thereof may be used in combination. Of these, amorphous polyester resins and vinyl resins such as styrene-acrylic resins are preferred.

The amorphous polyester resin can enhance the low-temperature fixability of the toner. The amorphous polyester resin may be any amorphous resin obtained by a polycondensation reaction of a carboxylic acid having two or more valences (polyvalent carboxylic acid) and an alcohol having two or more valences (polyhydric alcohol). Examples of the polyvalent carboxylic acid include unsaturated aliphatic polyvalent carboxylic acids, aromatic polyvalent carboxylic acids, and derivatives thereof. As long as the obtained polyester resin becomes amorphous, a saturated aliphatic polyvalent carboxylic acid may be used in combination. Examples of the above polyhydric alcohol include unsaturated aliphatic polyhydric alcohols, aromatic polyhydric alcohols, and derivatives thereof. As long as the obtained polyester resin becomes amorphous, a saturated aliphatic polyhydric alcohol may be used in combination. The polyhydric fatty acids and polyhydric alcohols may be used alone or as a mixture of two or more thereof.

The vinyl resin can harden the toner base particles to suppress the burial of the external additive into the toner base particles, and thereby enhance the improvement effect of the charging property and improvement effect of the cleaning property, each caused by strontium titanate Examples of the vinyl resins include (co)polymers of (meta)acrylic acid ester having straight-chain hydrocarbons of 6 to 30 carbon atoms, styrene (co)polymers, (co)polymers of other (meta)acrylic acid esters, (co)polymers of vinyl esters, (co)polymers of vinyl ethers, (co)polymers of vinyl ketones, and (co)polymers of accrylic acid or metallic acid.

The content of the vinyl resin is preferably 0.1% by mass or more and 20% by mass or less based on the total mass of the binder resin. When the content of the vinyl resin is 0.1% by mass or more, the effect of suppressing burial of the external additive is sufficiently exhibited. When the content of the vinyl resin is 20% by mass or less, the content of the other resin (particularly, an amorphous polyester resin) can be increased to easily enhance the low-temperature fixability of the toner.

(Crystalline Resin)

In this specification, a crystalline resin means a resin in which a melting point is observed in measurement by DSC.

The crystalline resin enhances the flexibility of the toner base particles and thereby enhances the bindability of strontium titanate particles contained in the external additive. In addition, the crystalline resin enhances the fixability of the toner. In addition, the crystalline resin covers the pigment particles thereby enhances the dispersibility of the pigment particles. As a result, the crystalline resin can keep distance between the pigment particles, prevent overlap of the pigment particles inside the formed image, and realize an even dispersion of the resin inside the formed image, which lead to an enhanced image density.

The content of the crystalline resin is preferably 3% by mass or more and 30% by mass or less, more preferably 5% by mass or more and 20% by mass or less, based on the total mass of the toner base particles. When the content of the amorphous resin is 3% by mass or more, the fixability of the toner can be further increased.

Examples of the crystalline resins include styrene resins, vinyl resins, olefin resins, epoxy resins, amorphous polyester resins, polyurethane resins, polyamide resins, cellulose resins, and polyether resins. One kind of these resins may be used alone, or two or more kinds thereof may be used in combination. Of these, amorphous polyester resins and vinyl resins such as styrene-acrylic resins are preferred.

The crystalline polyester resin can enhance the low-temperature fixability of the toner. In the present embodiment, the amount of the organic pigments contained inside the toner base particles tends to be large, and the organic pigments function as a nucleating agent for the crystalline polyester resin and thereby enhances the dispersibility of the crystalline polyester resin both in cooling step of manufacturing of the toner and in cooling step after fixation of the toner. Thus, the enhancement of the fixability and the image density by the crystalline polyester resin is significantly observed.

The crystalline polyester resin may be any crystalline resin obtained by a polycondensation reaction of a carboxylic acid having two or more valences (polyvalent carboxylic acid) and an alcohol having two or more valences (polyhydric alcohol).

The polyvalent carboxylic acid can be selected from: a two valent aliphatic dicarboxylic acid including oxalic acid, succinic acid, glutaric acid, adipic acid, speric acid, azelaic acid, sebacic acid, 1,9-nonanedicarboxylic acid, 1,10-decanedicarboxylic acid, dodecanedicarboxylic acid (1,12-dodecanedicarboxylic acid), 1,14-tetradecanedicarboxylic acid, 1,18-octadecanedicarboxylic acid, and the like, and a two valent aromatic dicarboxylic acid including phthalic acid, isophthalic acid, terephthalic acid, naphthalene-2,6-dicarboxylic acid, malonic acid, mesaconic acid, and the like. These polyvalent carboxylic acids may be anhydrides or lower alkyl esters.

Alternatively, the above polyvalent carboxylic acid may be a carboxylic acid having three or more valences such as 1,2,4-benzenetricarboxylic acid, 1,2,5-benzenetricarboxylic acid, 1,2,4-naphthalenetricarboxylic acid, and the like, and an anhydride or a lower alkyl ester thereof. Further, unsaturated polyvalent carboxylic acids including maleic acid, fumaric acid, 3-hexenedioic acid, and 3-octenedioic acid and the like may be used.

The polyhydric alcohol is preferably an aliphatic diol, and more preferably a linear aliphatic diol having 7 or more and 20 or less carbon atoms in the main chain portion. In particular, the linear aliphatic diol easily enhances the crystallinity of the polyester resin and hardly lowers the melting temperature. Thus, the linear aliphatic diol can further enhance the blocking resistance, the image storage property, and the low-temperature fixability of the toner. When the number of carbon atoms of the linear aliphatic diol is 7 or more and 20 or less, the melting point at the time of polycondensation with the polyvalent carboxylic acid component can be made lower, and synthesis becomes easier.

Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, and 1,18-octadecanediol. Alternatively, an alcohol having 3 or more valences including glycerin, trimethylolethane, trimethylolpropane, pentaerythritol, and the like may be used.

The weight average molecular weight of the crystalline polyester resin is preferably 5.000 or more and 50,000 or less. Note that, in this specification, the weight average molecular weight of the crystalline polyester resin is a value measured by gel permeation chromatography (GPC), for example, by the following method.

Tetrahydrofuran (THF) is flowed as a carrier solvent at a flow rate of 0.2 mL/min while using HLC-8120GPC manufactured by Tosoh Corporation as a device and TSKguardcolutmn+TSKgelSuperHZ-M3 ream manufactured by Tosoh Corporation as a column and holding the column temperature at 40° C. As the measurement sample (resin), a solution dissolved in tetrahydrofuran so as to have a concentration of 1 mg/nil is used. The solution can be obtained by treatment with an ultrasonic disperser at room temperature for 5 minutes and then with a membrane filter with a pore size of 0.2 μm. 10 μL of this sample solution is injected into the apparatus together with the carrier solvent and detected using a refractive index detector (RI detector). The molecular weight distribution of the measurement sample is calculated based on a calibration curve generated using monodisperse polystyrene standard particles.

1-1-2. Organic Pigment

The organic pigment is a pigment composed of an organic compound. In this embodiment, for the purpose of adjusting the color to be developed and adjusting the physical properties of the toner, two or more kinds of pigments are internally added into one toner base particle.

The two or more kinds of pigments may be any combination dependent on the color to be developed by the toner. For example, a toner for developing black image preferably contains a bleu pigment and a violet pigment as the two or mom kinds of pigments. These pigments can enhance image density of the developed image and make the black hue better.

The blue pigment may be C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 16, C.I. Pigment Blue 56, C.I. Pigment Blue 60, C.I. Pigment Blue 61, and C.I. Pigment Blue 80, and the like.

Of these, from the viewpoint of making the hue better, further enhancing the conductivity and light resistance, and hardly reducing the transmittance of electromagnetic waves in the near-infrared region, the blue pigment is preferably a phthalocyanine pigment. Examples of a blue pigment which is a phthalocyanine pigment include C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6 and C.I. Pigment Blue 16, and the like.

From the viewpoint of enhancing the image density, the blue pigment is preferably a copper phthalocyanine pigment. Example of a blue pigment which is a copper phthalocyanine pigment include Pigment Blue 15:3 and C.I. Pigment Blue 15:4.

The violet pigment may be C.I. Pigment Violet 19, C.I. Pigment Violet 23, C.I. Pigment Violet 24, C.I. Pigment Violet 32, and the like.

Of these, enhancing the image density, the violet pigment is preferably C.I. Pigment Violet 19, C.I. Pigment Violet 23, and C.I. Pigment Violet 32, and more preferably C.I. Pigment Violet 23.

The toner base particle may contain other pigments. From the viewpoint of further enhancing the image density and making the black hue better, the other pigments is preferably selected such that a combination of organic pigments having a difference in absorption maximum wavelength λ max of 50 nm or more and 240 nm or less is internally added into the toner base particles.

From the viewpoint of sufficiently absorbing electromagnetic waves of a wider wavelength in the visible light region and making the black hue better, it is preferable that the toner base pigments contain, in addition to the blue pigments and the violet pigments, a pigment P1 having an absorption maximum wavelength λ max in a wavelength region of larger than 400 nm and 530 nm or less.

Further, among a pigment P1-1 in which an absorption maximum wavelength λ max is larger than 400 nm and less than 460 nm, and a pigment P1-2 in which an absorption maximum wavelength λ max is equal to or larger than 460 nm and equal to or smaller than 530 nm, it is preferable that the pigment P1 contains at least a pigment P1-2. The pigment P1-2 is often a pigment having low resistance, and it hardly causes a decrease in charging property due to excessive charging of the toner.

On the other hand, from the viewpoint of more sufficiently absorbing electromagnetic waves having a wider wavelength in the visible light region, the toner base particles preferably include both of the pigment P1-1 and the pigment P1-2. When the toner base particles contain more types of organic pigments, even if any of the pigments fades, the other pigment can cover the wavelength range of the faded pigment, so that the light resistance of the formed image can be further increased. Further, according to the findings of the present inventors, the more the type of pigment, the higher the toner fixability, probably due to the higher dispersibility of the crystalline resin (particularly, a crystalline polyester resin).

The pigment P1-1 may be a monoazo pigment, a disazo pigment, a benzimidazoline pigment, an isoindolinone pigment, an isoindoline pigment and a perinone pigment, and the like. Specifically, the pigment P1-1 may be C.I. Pigment Yellow 1, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 81, C.I. Pigment Yellow 83, C.I. Pigment Yellow 87, C.I. Pigment Yellow 97, C.I. Pigment Yellow 111, C.I. Pigment Yellow 120, C.I. Pigment Yellow 126, C.I. Pigment Yellow 127, C.I. Pigment Yellow 128, C.I. Pigment Yellow 139, C.I. Pigment Yellow 151, C.I. Pigment Yellow 154, C.I. Pigment Yellow 155, C.I. Pigment Yellow 173, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, C.I. Pigment Yellow 194, C.I. Pigment Yellow 196, C.I. Pigment Yellow 213, C.I. Pigment Yellow 214, C.I. Pigment Yellow 217, C.I. Pigment Green 7, C.I. Pigment Green 36, C.I. Pigment Green 254, and C.I. Pigment Orange 43, and the like.

Of these, as the pigment P1-1, C.I. Pigment Yellow 74, C.I. Pigment Yellow 120, C.I. Pigment Yellow 139, C.I. Pigment Yellow 151, C.I. Pigment Yellow 155, C.I. Pigment Yellow 180, C.I. Pigment Yellow 181, C.I. Pigment Yellow 185, C.I. Pigment Yellow 213, C.I. Pigment Green 7, C.I. Pigment Green 36, and C.I. Pigment Green 254 are preferred.

Pigment P1-2 can be pigments such as monoazo pigments, disazo pigments, condensed azo pigments, naphthol AS pigments, benzimidazolone pigments, and the like. Specifically, the pigment P1-2 may be C.I. Pigment Brown 23, C.I. Pigment Brown 25, C.I. Pigment Brown 41, and C.I. Pigment Red 38, and the like.

The total content of the above pigments is preferably 1% by mass or more and 30% by mass or less, more preferably 5% by mass or more and 20% by mass or less, and still more preferably 7% by mass or more and 20% by mass or less, based on the total mass of the toner base particles. By increasing the content of the pigments, it is possible to further improve the color developability of the image to be formed. On the other hand, when the total content of the pigments is 30% by mass or less, a sufficient amount of the binder resin can be contained in the toner base particles, so that the toner becomes flexible and the fixability of the image is sufficiently increased, and the desorption of strontium titanate is less likely to occur.

Especially when the total content of the above pigments is 5% by mass or more or 7% by mass or more, an image having a sufficient color density can be formed by a less amount of toner, resulting in a less amount of deposited and used toner, which contributes is reduction of environmental load.

1-1-3. Carbon Black

Carbon black is a black pigment mainly composed of carbon atoms. Types of carbon black is not specifically limited, and any types of channel black, furnace black, acetylene black, thermal black, and lamp black. The carbon blacks may be subjected to surface treatment.

In the present embodiment, the carbon black stabilizes the charging property of the toner which is shifted to high electrical resistance by the internal addition of the two or more kinds of organic pigments.

The total content of carbon black is preferably more than 0.1% by mass and less than 3.0% by mass, and more preferably more than 0.1% by mass and less than 1.0% by mass, based on the total content of the toner base particles and the external additives. When the content of carbon black is more than 0.1% by mass, the stabilizing effect of charging property by carbon black is sufficiently achieved. When the content of carbon black is less than 3.0% by mass, the decrement of charging property especially at the early stage of image forming, occurred by decrement of charge retention ability of the toner, which leads to leakage, due to the high conductivity of carbon black, hardly occurs.

1-1-4. Other Ingredients

The toner base particles may contain other ingredients including a release agent (wax) and a charge control agent, and the like.

The release agent can enhance the releasability of the toner from the fixing member or the like.

Examples of the release agents include hydrocarbon waxes including polyethylene waxes, paraffin waxes, microcrystalline waxes. Fischer-Tropsch waxes and the like, dialkyl ketone waxes including distearyl ketone and the like; ester waxes including carnauba waxes, behenyl behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, trimellitic acid tristearyl, distearyl maleate and the like; and amide waxes including ethylenediamine dibehenylamide, trimellitic acid tristearylamide and the like.

The content of the above release agent is preferably 2% by mass or more and 30% by mass or less, more preferably 5% by mass or more and 20% by mass or less, based on the total mass of the toner base particles. When the content of the above release agent is 2% by mass or more, the releasability of the toner from the fixing member is sufficiently increased. When the content of the above release agent is 30% by mass or less, a sufficient amount of the binder resin can be contained in the toner base particles, so that the fixability of the image is sufficiently increased.

The charge control agent can adjust the charging property of the toner base particles.

Examples of the charge control agent include a nigrosine dye, a metal salt of a naphthenic acid or a higher fatty acid, an alkoxylated amine, a quaternary ammonium salt compound, an azo metal complex, a salicylic acid metal salt or a metal complex thereof, and the like.

The content of the charge control agent is preferably 0.1% by mass or more and 10% by mass or less, more preferably 0.5% by mass or more and 5% by mass or less, based on the total mass of the binder resin. When an attempt is made to control the charging property of the toner by a method such as excessively adding the charge control agent, other characteristics of the toner base particles may vary greatly. In contrast, in this embodiment, by adjusting the charging property of the toner by strontium titanate, it is possible to adjust the charging property of the toner to a desired degree while satisfying other required characteristics.

1-2. External Additive

The external additive includes particles of strontium titanate. The external additive may contain other components.

1-2-1. Strontium Titanate

Strontium titanate can stabilize the charging property of the toner and improve the cleaning property of the toner. In this embodiment, the charging property and the like of the toner are adjusted by including strontium titanate in the external additive. Therefore, it is not necessary to greatly change the components and the like of the toner base particles, and it is possible to adjust the charging property and the cleaning property while maintaining the characteristics of the toner base particles.

In addition, strontium titanate has high positive charging property. Thus, strontium titanate, which has been dropped off from by the toner base particles due to friction of the toner particles at the time of development, is imparted with a polarity opposite to that of the toner due to the above friction. The dropped-off strontium titanate thus moves to and collects in non-image portion where the toner particles do not exist, and remains on the image carrier without being transferred to the recording medium. Then, the remained strontium titanate accumulates between the cleaning member and the image carrier, thereby preventing leakage of the toner from the cleaning member. As such, strontium titanate is considered to further enhance the cleaning property of the toner.

Strontium titanate can be of any of a plurality of particle shapes, either cubic or rectangular parallelepiped, irregular, and rounded cubic, depending on the method of manufacture or composition thereof. In this embodiment, strontium titanate may have any particle shape among these. For example, strontium titanate having a cubic shape or a rectangular parallelepiped shape can remove a charged product which is thinly adhered to the surface of an image carrier by an edge of its shape, so that the charging property of the toner is easily improved. Further, strontium titanate having an irregular shape tends to easily adhere to the surface of the toner base particles, so that fusion (filming) of the toner base particles to the image carrier is suppressed and cleaning property of the toner is easily enhanced. Strontium titanate having a cubic shape with a rounded corner has both of these characteristics, so that it is easy to enhance the cleaning property while improving the charging property of the toner.

The shape of the particles of strontium titanate can be confirmed by observation by scanning electron microscopy (SEM)

Strontium titanate in a cubic shape or a rectangular parallelepiped shape can be obtained by a manufacturing method not passing through a firing step (wet method). Specifically, it can be synthesized by adding a hydroxide of strontium to a titania sol dispersion obtained by adjusting the pH of a hydrous titanium oxide slurry obtained by hydrolyzing an aqueous solution of titanyl sulfate, and warming it to a reaction temperature. From the viewpoint of bringing the crystallinity and the particle diameter of the titania sol into a desired range, the above-mentioned hydrous titanium oxide slurry preferably has a pH of 0.5 or more and 1.0 or less. In addition, for the purpose of removing ions adsorbed on the titania sol particles, it is preferable to add an alkaline material such as, for example, sodium hydroxide and Sr(OH)₂.8H₂O to the dispersion of the titania sol. At this time, in order not to adsorb alkali metal ions or the like on the surface of the hydrous titanium oxide, it is preferable that the slurry is not made more than pH 7. In addition, the reaction temperature is preferably 60° C. or more and 100° C. or less, and in order to obtain a desired particle size distribution, the temperature rise rate is preferably 30° C./time or less, and the reaction time is preferably 3 hours or more and 12 hours or less.

Strontium titanate of an irregular shape can be obtained by a firing method via a firing step. Specifically, strontium carbonate and titanium oxide are substantially equimolar weighed, mixed by a ball mill or the like, and then pressure molded, and calcined at 1000° C. or higher and 1500° C. or less, and then, by a method of pulverizing and classifying by mechanical grinding, strontium titanate of an irregular shape can be obtained. By appropriately changing the type of the raw material, the raw material composition, the molding pressure, the firing temperature, the pulverization and classification, the shape and the particle diameter of the obtained strontium titanate can be adjusted.

Strontium titanate in a rounded cubic shape can be obtained by the method of doping lanthanum into strontium titanate. Specifically, strontium titanate having a rounded cubic shape can be obtained by heating a slurry containing strontium oxide, lanthanum oxide and titanium oxide while stirring and mixing.

When lanthanum is doped into strontium titanate, in addition to the adjustment of the particle shape described above, it is possible to adjust the degree of spheronization according to the doping amount, or it is also possible to suppress the horny wear and scratch of the surface of the image carrier. Further, when lanthanum is doped into strontium titanate, the electric resistance tends to be further lowered, so that the charging property of the toner is more easily stabilized, and in particular, excessive charging of the toner under low-temperature and low-humidity (LL) environmental conditions can be prevented.

The lanthanum content ratio when strontium titanate contains lanthanum is preferably 3.0% by mass or more and 15.0% by mass or less. When the above lanthanum content is 3.0% by mass or more, the shape of strontium titanate becomes closer to the spherical shape, and the moisture adsorption can be further reduced. When the above lanthanum content is 15.0% by mass or less, generation of coarse particles can be prevented and charging property can be further stabilized.

Presence of lanthanum in Strontium titanate, and its content can be confirmed by X-ray fluorescence analysis (XRF). Specifically, 3 g of strontium titanate is pressurized and pelletized, and measurement is performed by qualitative analysis using a fluorescent X-ray analyzer (manufactured by Shimadzu Corporation, XRF-1700, and the like), and the presence of lanthanum can be confirmed by determining the Kα peak angle of the element measured from the 20 table.

The strontium titanate preferably has a particle diameter of a peak top in a number particle size distribution of less than 300 nm, more preferably 10 nm or more and 200 nm or less, still more preferably 10 nm or more and 100 nm or less, and particularly preferably 30 nm or more and 80 nm or less. When the above particle diameter of strontium titanate is less than 300 nm, the contact point between strontium titanate and the toner base particles is sufficiently increased, so that the adjusting action of the charging property can be more sufficiently exhibited, and in addition, destabilization of the charging property of the toner due to the desorption of strontium titanate hardly occurs. Further, when the above particle diameter of strontium titanate is less than 100 nm, in addition to the stabilization of charging property, scratching of the image carrier due to contact of the angle of strontium titanate hardly occurs. When the above particle diameter of strontium titanate is 10 nm or more, the effect of adjusting the charging property becomes more sufficient, and the fluidity of the toner does not become too high, so that the cleaning property of the toner tends to be good.

Particle size of the peak top in the number particle size distribution of strontium titanate can be obtained by image analysis of an image captured by observation with a scanning electron microscope (SEM). Specifically, of the 100 strontium titanate particles contained in the imaged image described above, the longest diameter and the shortest diameter of each particle are measured, and the sphere equivalent diameter of each strontium titanate particle is determined from intermediate value thereof. Then, the particle size of the peak top, in the number particle size distribution of the sphere equivalent diameter of the 100 strontium titanate particles, is determined as the particle size of the peak top in the number particle size distribution of strontium titanate.

The content of strontium titanate is preferably 0.3% by mass or more and 3.0% by mass or less, more preferably 0.5% by mass or more and 2.0% by mass or less, based on the total mass of the toner base particles. When the content of the above strontium titanate is 0.3% by mass or more, the charging property is more easily stabilized and the cleaning property is more easily enhanced. When the content of strontium titanate described above is 3.0 parts by mass or less, excessive charging due to strontium titanate desorbed from the toner base particles hardly occurs.

1-2-2. Other External Additives

The external additive may include particles mainly containing an inorganic material other than strontium titanate, such as silica particles, alumina particles, zirconia particles, zinc oxide particles, chromium oxide particles, cerium oxide particles, antimony oxide particles, tungsten oxide particles, tin oxide particles, tellurium oxide particles, manganese oxide particles and boron oxide particles. Particles containing these inorganic materials as a main component may be subjected to a hydrophobic treatment by a surface treatment agent such as a silane coupling agent or a silicone oil, if necessary. These particles preferably have a particle diameter of a peak top measured by a method similar to that of strontium titanate of 20 nm or more and 500 nm, and more preferably 70 nm or more and 300 nm or less.

The external additive may contain particles mainly containing an organic material containing a homopolymer such as styrene or methyl methacrylate or a copolymer thereof. It is preferable that these particles have a particle diameter of a peak top measured by a method similar to that of strontium titanate of 10 nm or more and 1000 nm or less.

The external additive may contain a lubricant such as a metal salt of a higher fatty acid. Examples of the higher fatty acid include stearic. Acid, oleic acid, palmitic acid, linoleic acid and ricinoleic acid and the like. Examples of the metal constituting the above metal salt include zinc, manganese, aluminum, iron, copper, magnesium and calcium.

The content of these external additives is preferably an amount in which the total amount of the external additive combined with strontium titanate is 0.05% by mass or more and 5.0% by mass or less based on the total mass of the toner base particles.

1-3. Method for Producing Toner Base Particles

The toner base particles can be produced in the same manner as a known toner, by an emulsion polymerization aggregation method, an emulsion aggregation method and the like.

According to the emulsion polymerization aggregation method, a dispersion of particles of a binder resin obtained by an emulsion polymerization method and a dispersion of particles of a pigment are mixed together with particles such as a releasing agent and a charge control agent to be optionally added, and these are aggregated, associated or fused until particles having a desired particle diameter are obtained, and then an external additive is added.

According to the emulsion aggregation method, a dispersion of particles of a binder resin obtained by dropping a solution obtained by dissolving a binder resin into a poor solvent can be obtained by mixing a dispersion of particles of a pigment with particles such as a releasing agent and a charge control agent to be optionally added, aggregating, associating or fusing them until particles having a desired particle diameter are obtained, and then adding an external additive.

In this embodiment, since two or more kinds of pigments are internally added to the toner particles, the amount of the pigment added tends to be large. Therefore, when preparing a dispersion of particles of a pigment, it is preferable to add a surfactant to the dispersion in order to enhance dispersion stability of the pigment.

1-4. Carrier

The carrier is mixed with the toner particles described above to constitute a two components magnetic toner. The carrier may be any known magnetic particles which may be contained in a toner.

Examples of the magnetic particles include particles including magnetic materials such as iron, steel, nickel, cobalt, ferrite, and magnetite, and alloys of these with aluminum and lead. The above carrier may be a coated carrier in which a surface of particles made of the magnetic materials is coated with a resin or the like, or may be a resin dispersion type carrier in which the above-mentioned magnetic body is dispersed in a binder resin. Examples of the resin for coating include olefin resins, styrene resins, styrene-acrylic resins, silicone resins, polyester resins, and fluororesins Examples of the binder resins include acrylic resins, styrene-acrylic resins, polyester resins, fluororesins, and phenolic resins.

The average particle diameter of the carrier preferably is 20 μm or more and 100 μm or less, and more preferably 25 μm or more and 80 μm or less, on a volume basis. Average particle size of the carrier can be measured by a laser diffractive particle size distribution measuring device with a wet disperser made by Sympatec (SYMPATEC) Co., Ltd. (HELOS) or the like.

The content of the carrier is preferably 2% by mass or more and 10% by mass or less based on the total mass of the toner particles and the carrier.

2. Image Forming Apparatus

Another embodiment of the present invention relates to an image forming apparatus including a toner image forming unit that develops an electrostatic latent image with toner to form a toner image, a fixing device that fixes the toner image to the recording medium by transferring the toner image to a recording medium, and an image forming method using the image forming layer. In this embodiment, the fixing device fixes the above-described toner to the recording medium.

The image forming apparatus may be a 4 cycle type image forming apparatus constituted by 4 color developing devices of yellow, magenta, cyan, and black, and 1 electrophotographic photoreceptors, or may be a tandem type image forming apparatus constituted by 4 color developing devices of yellow, magenta, cyan, and black, and 4 electrophotographic photoreceptors provided for each color.

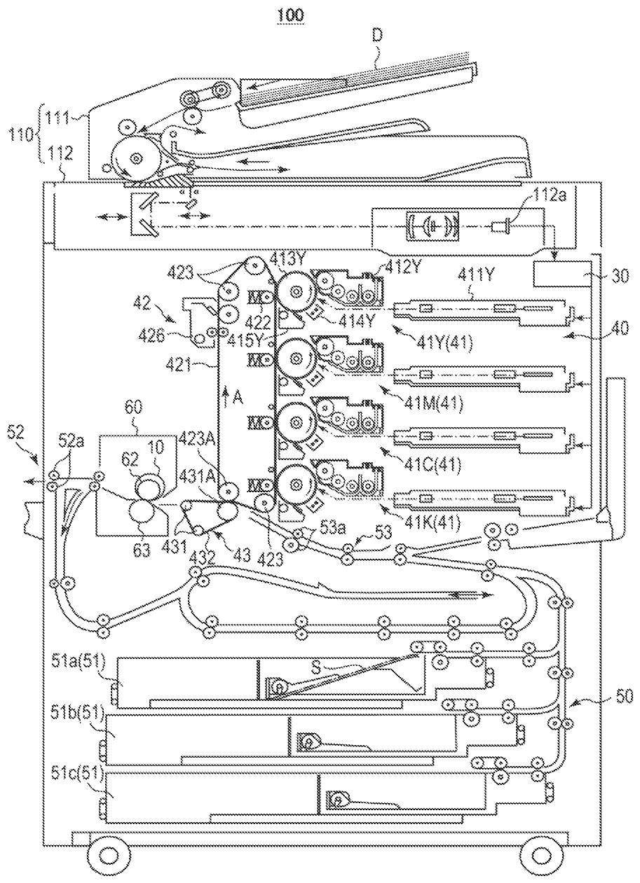

FIG. 1 is a schematic configuration diagram illustrating an example of an image forming apparatus 100 relating to the present embodiment. The image forming apparatus 100 illustrated in FIG. 1 includes an image reading unit 110, an image processing unit 30, an image forming unit 40, a paper conveying unit 50, and a fixing device 60.

The image forming unit 40 has an image forming unit 41Y, 41M. 41C and 41K for forming an image by each color toner of Y (yellow), M (magenta), C (cyan), and K (black). Since all of these units have the same configuration except for the toner to be stored, a symbol representing a color may be omitted hereinafter. The image forming unit 40 further includes an intermediate transfer unit 42 and a secondary transfer unit 43, these correspond to transfer devices.

In this embodiment, the toner described above is used as a toner of K.

The image forming unit 41 includes an exposure device 411, a developing device 412, an electrophotographic photoreceptor (image carrier) 413, a charging device 414, and a drum cleaning device 415. The charging device 414 is, for example, a corona charger. The charging device 414 may be a contact charging device in which a contact charging member such as a charging roller, a charging brush, or a charging blade is brought into contact with the electrophotographic photoreceptor 413 so as to be charged.

The exposure apparatus 411 includes, for example, a semiconductor laser as a light source and an optical deflection apparatus (polygon motor) that irradiates a laser beam corresponding to an image to be formed toward the electrophotographic photoreceptor 413. The electrophotographic photoreceptor 413 is a negatively charged organic photoreceptor having photoconductivity. The electrophotographic photoreceptor 413 is charged by a charging device 414.

The developing apparatus 412 is a developing device of a two components development system. The developing device 412 includes, for example, a developing container containing a two components developer, a developing roller (magnetic roller) rotatably disposed at an opening of the developing container, a partition wall for defining the wall of the developing container while the two components developer can move inside the developing container, a conveying roller for conveying the two components developer on the side of the opening in the developing container toward the developing roller, and a stirring roller for stirring the two components developer in the developing container. In the developing container, for example, a two components developer is contained.

The intermediate transfer unit 42 includes an intermediate transfer belt (intermediate transfer body) 421, a primary transfer roller 422 that presses the intermediate transfer belt 421 against the electrophotographic photoreceptor 413, a plurality of support rollers 423 including a backup roller 423A, and a belt cleaning device 426. The intermediate transfer belt 421 is looped over a plurality of support rollers 423. As at least one driving roller of the plurality of support rollers 423 rotates, the intermediate transfer belt 421 travels at a constant speed in the direction of the arrow A.

The belt cleaning device 426 has an elastic member 426a. The elastic member 426a abuts on the intermediate transfer belt 421 after the secondary transfer to remove the adhered matter on the surface of the intermediate transfer belt 421. The elastic member 426a is formed of an elastic body, and includes a cleaning blade, a brush, and the like.

The secondary transfer unit 43 has an endless secondary transfer belt 432, and a plurality of support rollers 431 including a secondary transfer roller 431A. The secondary transfer belt 432 is looped by a secondary transfer roller 431A and a support roller 431.

The fixing device 60 includes, for example, a fixing roller 62, an endless heat generating belt 10 that covers the outer peripheral surface of the fixing roller 62 and heats and melts the toner constituting the toner image on the sheet S, and a pressing roller 63 that presses the sheet S toward the fixing roller 62 and the heat generating belt 10. The sheet S corresponds to a recording medium.

The image forming apparatus 100 further includes an image reading unit 110, an image processing unit 30, and a sheet conveying unit 50. The image reading unit 110 includes a paper feeding device 111 and a scanner 112. The paper conveying unit 50 includes a paper feeding unit 51, a paper discharge unit 52, and a conveyance path unit 53. The three paper feed tray units 51a to 51c constituting the paper feed unit 51 store the sheet S (any of standard paper and special paper) identified based on the basis weight, the size, and the like for each set type in advance. The transport path unit 53 has a plurality of transport roller pairs such as a resist roller pair 53a.

Formation of an image by the image forming apparatus 100 will be described.

The scanner 112 optically scans and reads the document D on the contact glass. Reflected light from the document D is read by the CCD sensor 112a and becomes input image data. The input image data is subjected to predetermined image processing in the image processing unit 30 and is sent to the exposure apparatus 411.

The electrophotographic photoreceptor 413 rotates at a constant circumferential speed. The charging device 414 uniformly charges the surface of the electrophotographic photoreceptor 413 to a negative polarity. In the exposure apparatus 411, the polygon mirror of the polygon motor rotates at a high speed, and the laser beam corresponding to the input image data of each color component is developed along the axial direction of the electrophotographic photoreceptor 413 and is irradiated to the outer peripheral surface of the electrophotographic photoreceptor 413 along the axial direction. Thus, an electrostatic latent image is formed on the surface of the electrophotographic photoreceptor 413.

In the developing device 412, toner particles are charged by stirring and conveying of the two components developer in the developing container, and the two components developer is conveyed to the developing roller to form a magnetic brush on the surface of the developing roller. The charged toner particles electrostatically adhere from the magnetic brush to the portion of the electrostatic latent image in the electrophotographic photoreceptor 413. In this way, the electrostatic latent image of the surface of the electrophotographic photoreceptor 413 is visualized, and a toner image corresponding to the electrostatic latent image is formed on the surface of the electrophotographic photoreceptor 413. The “toner image” refers to a state in which the toner is assembled in an image form.

The toner image on the surface of the electrophotographic photoreceptor 413 is transferred to the intermediate transfer belt 421 by the intermediate transfer unit 42. The transfer residual toner remaining on the surface of the electrophotographic photoreceptor 413 after transfer is removed by a drum cleaning device 415 having a drum cleaning blade which is slidably brought into contact with the surface of the electrophotographic photoreceptor 413.

By pressing the intermediate transfer belt 421 against the electrophotographic photoreceptor 413 by the primary transfer roller 422, a primary transfer nip is formed for each electrophotographic photoreceptor by the electrophotographic photoreceptor 413 and the intermediate transfer belt 421. In the primary transfer nip, toner images of each color are sequentially overlapped and transferred onto the intermediate transfer belt 421.

On the other hand, the secondary transfer roller 431A is pressed against the back-up roller 423A via the intermediate transfer belt 421 and the secondary transfer belt 432. Thereby, a secondary transfer nip is formed by the intermediate transfer belt 421 and the secondary transfer belt 432. Sheet S passes through the secondary transfer nip. The sheet S is conveyed to the secondary transfer nip by the sheet conveying unit 50. The correction of the inclination of the sheet S and the adjustment of the timing of the conveyance are performed by the resist roller portion in which the resist roller pair 53a is disposed.

When the sheet S is conveyed to the secondary transfer nip, a transfer bias is applied to the secondary transfer roller 431A. By applying this transfer bias, a toner image carried on the intermediate transfer belt 421 is transferred onto the sheet S (a step of adhering the toner for developing an electrostatic charge image to the recording medium). The sheet S to which the toner image has been transferred is com-eyed toward the fixing device 60 by the secondary transfer belt 432.

Attachments such as transfer residual toner remaining on the surface of the intermediate transfer belt 421 after the secondary transfer are removed by the belt cleaning device 426 having a cleaning blade winch is slidably brought into contact with the surface of the intermediate transfer belt 421. At this time, since the aforementioned intermediate transfer member is used as the intermediate transfer belt, the dynamic friction force can be reduced over time.

The fixing device 60 forms a fixing nip by the heat generating belt 10 and the pressure roller 63, and heats and pressurizes the conveyed sheet S at the fixing nip section. Thus, the toner image is fixed to the sheet S (a step of fixing the toner for electrostatic charge image development to the recording medium). The sheet S on which the toner image is fixed is discharged outside the machine by a sheet discharge unit 52 provided with a sheet discharge roller 52a.

Note that the apparatus configuration and the image forming method described above are exemplary forms for carrying out the present invention, and the present invention is not limited thereto.

For example, a monochromatic image using only the above-mentioned toners may be formed, or an image using only the above-mentioned toners toner and the toner that absorbs electromagnetic waves in the near-infrared region may be formed, by an apparatus corresponding thereto.

### EXAMPLES

Hereinafter, the present invention will be described in more detail with reference to Examples, but the present invention is not limited thereto.

Note that, in the following examples, when there is no particular reference, the average particle diameter of each particle is a value measured using Microtrack Co., Ltd. Microtrack UPA-150 (“MICROTRAC, registered trademark of the company).

1. Preparation of the toner

1-1. Preparation of Pigment Particle Dispersions

1-1-1. Preparation of Pigment Particle Dispersion (P1)
C.I. Pigment Blue 15:3 (PB15:3): 50 parts by mass
C.I. Pigment Violet 23 (PV23): 50 parts by mass
Anionic surfactant: 15 parts by mass
Ion exchange water: 400 parts by mass

The above components were mixed and pre-dispersed by a homogenizer (manufactured by IKA Co., Ltd., Ultratalax) for 10 minutes, and then subjected to a dispersion treatment using a high pressure impact type disperser (manufactured by Sugino Machine Co., Ltd., Altimizer) for 30 minutes 245 MPa pressure to obtain an aqueous dispersion of particles containing these pigments. A pigment particle dispersion (P1) was prepared by adding ion-exchanged water to the obtained dispersion to adjust the solid content to 15% by mass. The average particle diameter on a volume basis of the pigment particles in the pigment particle dispersion (P1) was 120 nm.

The above anionic surfactant is Neogen RK manufactured by Dai-ichi Kogyo Seiyaku Co., Ltd (“Neogen” is a registered trademark of the company).

1-1-2. Preparation of Pigment Particle Dispersion (P2)

A pigment particle dispersion (P2) was prepared in the same manner as in the preparation of the pigment particle dispersion (P1), except that C.I. Pigment Violet 24 (PV24) was used instead of C.I. Pigment Violet 23. The average particle diameter on a volume basis of the pigment particles in the pigment particle dispersion (P2) was 120 nm.

1-1-3. Preparation of Pigment Particle Dispersion (P3)

A pigment particle dispersion (P3) was prepared in the same manner as in the preparation of the pigment particle dispersion (P1), except that C.I. Pigment Blue 16 (PB16) was used instead of C.I. Pigment Blue 15:3. The average particle diameter on a volume basis of the pigment particles in the pigment particle dispersion (P3) was 120 nm.

1-14. Preparation of Pigment Particle Dispersion (P4)

A pigment particle dispersion (P4) was prepared in the same manner as in the preparation of the pigment particle dispersion (P1), except that each the same amount of C.I. Pigment Brown 25 (PBr25) and C.I. Pigment Red 369 (PR269) was used instead of C.I. Pigment Blue 15:3 and C.I. Pigment Violet 23 The average particle diameter on a volume basis of the pigment particles in the pigment particle dispersion (P4) was 120 nm.

1-1-5. Preparation of Pigment Particle Dispersion (P5) A pigment particle dispersion (P5) was prepared in the same manner as in the preparation of the pigment particle dispersion (P1), except that 100 parts by mass of C 1. Pigment Blue 15:3 was used instead of C.I. Pigment Violet 23. The average particle diameter on a volume basis of the pigment particles in the pigment particle dispersion (P5) was 120 nm.

1-1-6. Preparation of Pigment Particle Dispersion (CB)

A pigment particle dispersion (CB) was prepared in the same manner as in the preparation of the pigment particle dispersion (P1), except that each the same amount of carbon black was used instead of C.I. Pigment Blue 15:3 and C.I. Pigment Violet 23. The carbon black used was Regal 330 by Cabot Corp. The average particle diameter on a volume basis of the pigment particles in the pigment particle dispersion (CB) was 120 nm.

1-2. Preparation of Amorphous Resin Particle Dispersions

1-2-1. Preparation of Amorphous Polyester Resin Particle Dispersion (a1)

A mixed liquid of a monomer of a vinyl resin described below, a monomer having a substituent that reacts with both an amorphous polyester resin and a vinyl resin, and a polymerization initiator (di-t-butylperoxide) was placed in a dropping funnel.
Styrene: 80.0 parts by mass
N-butyl acrylate: 20.0 parts by mass
Acrylic acid: 10.0 parts by mass
Polymerization initiator: 16.0 parts by mass

Further, the following monomer serving as a raw material of an amorphous polyester resin was placed in a 4 necked flask equipped with a nitrogen introducing pipe, a dehydrating pipe, a stirrer, and a thermocouple, and heated to 170° C. and dissolved.
Bisphenol A ethylene oxide 2 molar adduct: 50.2 parts by mass
Bisphenol A propylene oxide 2 molar adduct: 249.8 parts by mass
Terephthalic acid: 120.1 parts by mass
Dodecenyl succinic acid: 46.0 parts by mass

Under stirring, the mixed liquid placed in the dropping funnel was added dropwise to the 4 necked flask over 90 minutes, and after aging for 60 minutes, unreacted monomers were removed under reduced pressure (8 kPa). Thereafter, 0.4 parts by mass of Ti(OBu)₄ was charged as an esterification catalyst, and the temperature was raised to 235° C., under normal pressure (101.3 kPa) for 5 hours, further under reduced pressure (8 kPa) for 1 hour, the reaction was carried out. Then, the mixture was cooled to 200° C., and the reaction was carried out under reduced pressure (20 kPa), followed by desolvation to obtain an amorphous polyester resin particle dispersion (a1) containing an amorphous polyester resin (A1). The obtained amorphous polyester resin (A1) had a weight average molecular weight (Mw) of 24000 and an acid value of 18.2 mgKOH/g.

1-2-2. Preparation of Amorphous Vinyl Resin Particle Dispersion (s1)

(First Stage Polymerization)

To a 5 L reaction vessel fitted with a stirring device, a temperature sensor, a cooling pipe and a nitrogen introducing device, 8 parts by mass of sodium dodecyl sulfate and 3000 parts by mass of ion-exchanged water were charged, and the internal temperature was raised to 80° C. while stirring at a stirring speed of 230 rpm under a nitrogen stream. After raising the temperature, a solution in which 10 parts by mass of potassium persulfate was dissolved in 200 parts by mass of ion-exchanged water was added, and again the liquid temperature was raised to 80° C. and a mixture of the following monomers was added dropwise over a period of 1 hours
Styrene: 480.0 parts by mass
N-butyl acrylate: 250.0 parts by mass
Methacrylic acid: 68.0 parts by mass

After dropwise addition of the above mixed liquid, polymerization of the monomer was carried out by heating at 80° C. for 2 hours and stirring to prepare a vinyl-based resin particle dispersion liquid S1.

(2nd Stage Polymerization)

To a 5 L reaction vessel fitted with a stirring device, a temperature sensor, a cooling pipe and a nitrogen introducing device, 1100 parts by mass of ion-exchanged water and 55 parts by mass (based on solid content) of the vinyl-based resin particle dispersion liquid S1 prepared by the first stage polymerization were charged and heated to 87° C. Thereafter, a mixed liquid obtained by dissolving the following monomer, a chain transfer agent (n-octyl-3-mercaptopropionate) and a release agent (paraffin wax: manufactured by Nippon Seiwax Co., Ltd., HNP0190) at 85° C., was subjected to a mixing and dispersing treatment for 10 minutes by a mechanical disperser (manufactured by Em-Technic Co., Ltd., CLEARMIX) having a circulation path to prepare a dispersion liquid containing emulsified particles (oil droplets). This dispersion was added to the above 5 L reaction vessel, and a solution of a polymerization initiator in which 5.4 parts by mass of potassium persulfate was dissolved in 103 parts by mass of ion-exchanged water was added, and the polymerization was carried out by heating and stirring the system at 87° C. for 1 hours to prepare a vinyl-based resin particle dispersion S1′.
Styrene: 256.5 parts by mass
2-ethylhexyl acrylate: 95.3 parts by mass
Methacrylic acid: 38.2 parts by mass
Chain transfer agent: 4.0 parts by mass
Release agent: 131.0 parts by mass

(Third Stage Polymerization)

To the vinyl-based resin particle dispersion S1′ obtained by the above second stage polymerization, a solution obtained by dissolving 7.3 parts by mass of potassium persulfate in 157.9 parts by mass of ion-exchanged water was further added. Further, under temperature conditions of 84° C. a mixture of the following monomers and a chain transfer agent (n-octyl-3-mercaptopropionate) was added dropwise over 90 minutes.
Styrene: 370.0 parts by mass
N-butyl acrylate 165.0 parts by mass
Methacrylic acid: 40.0 parts by mass
Methyl methacrylate: 47.2 parts by mass
Chain transfer agent: 8.6 parts by mass

After completion of the dropwise addition, the polymerization was carried out by heating and stirring for 2 hours, and then cooled to 28° C. thereby obtaining an amorphous vinyl resin particle dispersion (s1).

1-3. Preparation of Crystalline Resin Particle Dispersions

A raw monomer of the following addition polymerization system resin (styrene acrylic resin: StAc) unit and a polymerization initiator (di-t-butylperoxide) containing both reactive monomers were placed in a dropping funnel.
Styrene: 40.0 parts by mass
N-butyl acrylate: 16.0 pals by mass
Acrylic acid: 3.5 parts by mass
Polymerization initiator: 8.0 parts by mass

Further, a raw material monomer of the polycondensation-based resin (crystalline polyester resin: CPEs) unit described below was placed in a 4 necked flask equipped with a nitrogen introduction pipe, a dehydration pipe, a stirrer, and a thermocouple, and heated to 170° C. and dissolved.
Tetradecanedioic acid: 280 parts by mass
1,4-butanediol 105 parts by mass

Then, the above monomers were put into a reaction vessel equipped with a stirrer, a thermometer, a cooling pipe, and a nitrogen gas introduction pipe, and the inside of the reaction vessel was replaced with dry nitrogen gas 0.4 parts by mass of Ti(O-n-Bu)₄ was added to the obtained mixed solution, the temperature was raised to 235° C., and was further reacted under normal pressure (101.3 kPa) for 5 hours, and under reduced pressure (8 kPa) for 1 hour. Then, after cooling the obtained reaction solution to 200° C., under reduced pressure (20 kPa), the reaction was carried out such that acid value calculated by the measurement method described above was to be 20.0 mgKOH/g after the introduction of a nucleating agent.

Then, after the pressure of the reaction tank was gradually opened and returned to normal pressure, 20.3 parts by mass of stearic acid was added as the crystal nucleating agent, and the reaction was carried out at a temperature of 200° C. for 1.5 hours under normal pressure. Thereafter, the reaction tank was reacted for 2.5 hours under reduced pressure to 5 kPa at 200° C. to obtain a crystalline resin (C). The weight average molecular weight (Mw) of the crystalline resin (C) was 11,500, and the acid value was 20.0 mgKOH/g.

174.3 Part by mass of crystalline resin (C) was added to 102 parts by mass of methyl ethyl ketone and stirred at 75° C. for 30 minutes to dissolve. Then, 3.1 parts by mass of a 25% by mass aqueous sodium hydroxide solution was added to this dissolution solution. This dissolution solution was placed in a reaction vessel having an agitator, and while stirring, 375 parts by mass of water warmed to 70° C. was added dropwise and mixed over a period of 70 minutes. During the dropping, the liquid in the container became white turbid, and an emulsified state was uniformly obtained after the entire amount of the liquid was dropped.

Then, white keeping this emulsified liquid at 70° C., using a diaphragm type vacuum pump (manufactured by BUCHI Co., Ltd. V-700), the mixture was stirred at 15 kPa (150 mbar) under reduced pressure for 3 hours, whereby methyl ethyl ketone was distilled and removed, and then cooled at a cooling rate of 6° C./min to obtain a crystalline polyester resin particle dispersion (c1) in which fine particles of a crystalline polyester resin (C1) were dispersed. The volume average particle diameter of the resin particles in the crystalline polyester resin particle dispersion (c1) was 202 nm.

1-3-2. Preparation of Crystalline Polyurethane Resin Particle Dispersion (c2)

To a reaction apparatus equipped with an agitator and a thermometer, 1000 parts by mass of isophorone diisocyanate, 830 parts by mass of 1,4-adipate (polyester diol consisting of 1,4-butanediol and adipic acid), 96.3 parts by mass of Stearic Acid as a crystal nucleating agent, and 250 parts by weight of methyl ethyl ketone were charged while introducing nitrogen. Thereafter, urethanization reaction was carried out at 80° C. for 6 hours. Next, 2128 parts by mass of ion-exchanged water was added while stirring, and then the reaction system was brought into a reduced pressure to desolvate, thereby obtaining a crystalline polyurethane resin particle dispersion (c2) in which fine particles of a crystalline polyurethane resin (C2) were dispersed.

1-4. Preparation of Mold Release Agent Particle Dispersion (W1)
Paraffin wax: 270 parts by mass
Anionic surfactant: 13.5 parts by mass
(60% active ingredient, 3% based on paraffin wax)
Ion exchange water: 21.6 parts by mass

The above materials were mixed, and the release agent was dissolved in a pressure discharge type homogenizer (Gorin Co., Ltd., Gorin homogenizer) at an internal liquid temperature of 120° C., followed by a dispersion treatment with a dispersion pressure of 5 MPa for 120 minutes, followed by a dispersion treatment with 40 MPa for 360 minutes, and then cooled to obtain a dispersion. Ion-exchanged water was added to adjust the solid content to 20% to prepare a release agent dispersion (W1). The average particle diameter on a volume basis of particles in the release agent dispersion (W1) was 215 nm.

The above paraffin wax is HNP0190 (melting temperature: 85° C.) manufactured by Nippon Seiwax Co., Ltd., and the above anionic surfactant is Neogen RK manufactured by Dai-ichi Kogyo Seiyaku Co., Ltd.

1-5. Preparation of Toner Base Particles

1-5-1. Preparation of Toner Base Particles (1)

To a reaction vessel fitted with a stirring device, a temperature sensor and a cooling tube, 480 parts by mass (based on the solid content) of an amorphous vinyl resin particle dispersion (s1) and 350 parts by mass of ion-exchanged water were charged. At room temperature (25° C.), a 5 mol/L aqueous sodium hydroxide solution was added to adjust the pH to 10. Further, 3.5 parts by mass (based on the solid content) of the pigment particle dispersion (CB) and 82.5 parts by mass (based on the solid content) of the pigment particle dispersion (P1) were charged, and 80 parts by mass of a 50% by mass aqueous magnesium chloride solution was added under stirring at 30° C. over 10 minutes. After standing the obtained dispersion for 5 minutes, the temperature was increased to 80° C. over 60 minutes, and after reaching 80° C. a crystalline polyester resin particle dispersion (c1) of 60 parts by mass (based on the solid content) was charged over 20 minutes, and the stirring speed was adjusted so that the growth rate of the particle diameter became 0.01μ m/min, and let grown until the median diameter on a volume basis measured by Coulter Multisizer 3 (manufactured by Coulter Beckman Co., Ltd.) became 6.0 μm.

Then, 60 parts by mass of an amorphous polyester resin particle dispersion (a1) (based on the solid content) was charged over a period of 30 minutes, and when the supernatant of the reaction solution became transparent, an aqueous solution in which 80 parts by mass of sodium chloride was dissolved in 300 parts by mass of ion-exchanged water was added to stop the growth of the particle diameter. Then, the mixture was stirred in a state of 80° C., and the let fusion of the particles proceed until the average circularity of the toner particles became 0.970, and then cooled at a temperature lowering rate of 0.5° C./min or more to reduce the liquid temperature to 30° C. or less.

Then, solid-liquid separation was performed, and the dehydrated toner cake was redispersed in ion-exchanged water, and the operation of solid-liquid separation was repeated 3 times and washed. After washing, the toner base particles (1) were obtained by drying at 35° C. for 24 hours.

1-5-2. Preparation of Toner Base Particles (2)

Toner base particles (2) were obtained in the same manner as in the preparation of toner base particles (1), except that 425.6 parts by mass (based on solid content) of amorphous polyester resin particle dispersion (a1) and 54.4 parts by mass (based on solid content) of release agent particle dispersion (W1) was used instead of amorphous vinyl resin particle dispersion (s1).

1-5-3. Preparation of Toner Base Particles (3)

Toner base particles (3) were obtained in the same manner as in the preparation of toner base particles (2), except that the same amount (based on solid content) of crystalline polyurethane resin dispersion (c2) was used instead of crystalline polyester resin dispersion (c1).

1-5-4. Preparation of Toner Base Particles (4)

Toner base particles (4) were obtained in the same manner as in the preparation of toner base particles (2), except that the same amount (based on solid content) of amorphous polyester resin dispersion (a1) was used instead of crystalline polyester resin dispersion (c1).

1-5-5. Preparation of Toner Base Particles (5)

Toner base particles (5) were obtained in the same manner as in the preparation of toner base particles (2), except that the amount of the pigment particle dispersion (CB) was changed to 0.35 parts by mass (based on solid content) and instead the amount of the amorphous vinyl resin particle dispersion (s1) was changed to 483.15 parts by mass (based on solid content).

1-5-6. Preparation of Toner Base Particles (6)

Toner base particles (6) were obtained in the same manner as in the preparation of toner base particles (2), except that the amount of the pigment particle dispersion (CB) was changed to 20.0 parts by mass (based on solid content) and instead the amount of the amorphous vinyl resin particle dispersion (s1) was changed to 463.5 parts by mass (based on solid content).

1-5-7. Preparation of Toner Base Particles (7)

Toner base particles (7) were obtained in the same manner as in the preparation of toner base particles (2), except that the amount of the pigment particle dispersion (CB) was changed to 21.0 parts by mass (based on solid content) and instead the amount of the amorphous vinyl resin particle dispersion (s1) was changed to 462.5 parts by mass (based on solid content).

1-5-8. Preparation of Toner Base Particles (8)

Toner base particles (8) were obtained in the same manner as in the preparation of toner base particles (2), except that the same amount (based on solid content) of pigment particle dispersion (P2) was used instead of pigment particle dispersion (P1)

1-5-9. Preparation of Toner Base Particles (9)

Toner base particles (9) were obtained in the same manner as in the preparation of toner base particles (2), except that the same amount (based on solid content) of pigment particle dispersion (P3) was used instead of pigment particle dispersion (P1).

1-5-10. Preparation of Toner Base Particles (10)

Toner base particles (10) were obtained in the same manner as in the preparation of toner base particles (2), except that the same amount (based on solid content) of pigment particle dispersion (P4) was used instead of pigment particle dispersion (P1).

1-5-11. Preparation of Toner Base Particles (11)

Toner base particles (11) were obtained in the same manner as in the preparation of toner base particles (2), except that the pigment particle dispersion (CB) was omitted and instead the amount of the amorphous vinyl resin particle dispersion (s1) was changed to 483.5 parts by mass (based on solid content).

1-5-12. Preparation of Toner Base Particles (12)

Toner base particles (12) were obtained in the same manner as in the preparation of toner base particles (2), except that the same amount (based on solid content) of pigment particle dispersion (P5) was used instead of pigment particle dispersion (P1).

1-6. Preparation of Strontium Titanate

A hydrous titanium oxide slurry obtained by hydrolyzing an aqueous solution of titanyl sulfate was washed with an aqueous alkali solution. Then, using hydrochloric acid, the pH of the slurry of the hydrous titanium oxide after washing was adjusted to 1.0 to obtain a titania sol dispersion. NaOH was added to the obtained titania sol dispersion thereby the pH of the dispersion was adjusted to 5.0. After repeating the washing until the electric conductivity of the supernatant liquid became 74 μS/cm, a Sr(OH)₂.8H₂O in a molar amount of 0.98 times to the hydrous titanium oxide was added, and placed in a reaction vessel made of SUS and nitrogen gas was replaced. Further, distilled water was added so that the concentration in terms of SrTiO₃ was 0.47 mol/liter. The slurry in the reaction vessel was heated at 10° C./hour until 84° C. in a nitrogen atmosphere, and the reaction was carried out for 4.1 hours after reaching 84° C. After the reaction, the mixture was cooled to room temperature, and after removing the supernatant liquid, washing was repeated with pure water, and then filtration was performed by a Nutchet. The obtained cake was dried to obtain strontium titanate fine particles having a peak top particle diameter of 35 nm.

A normal paraffin wax (Mw: 500) solution dissolved in isopropanol and a n-octyltriethoxysilane were added to the strontium titanate fine particles obtained above, and the temperature was increased to 60° C. over 1 hours, whereby 100 parts by mass of strontium titanate fine particles were coated with 3.0 parts by mass of n-octyltriethoxysilane and 9.0 parts by mass of normal paraffin wax. Thereafter, filtration and washing were performed to obtain a wet cake, which was dried by heat treatment at 60° C. overnight to obtain a surface-treated strontium titanate particles A1.

The shape of the obtained strontium titanate particles A 1 observed by SEM was a substantially cubic or rectangular parallelepiped shape, and its peak top particle diameter was 40 nm.

Note that the peak top particle diameter of strontium titanate fine particles in a cubic shape or a rectangular parallelepiped shape was measured by the following method. Scanning electron microscopy (SEM) (manufactured by Nippon Electronics Co., Ltd., JSM-7401F) was used to observe strontium titanate fine particles at a magnification of 40000×, and the longest diameter and the shortest diameter for each particle were measured by image analysis of the primary particles, and the intermediate value thereof was set as a sphere equivalent diameter. Then, to determine the number particle size distribution based on the particle diameter and the number of 100 primary particles measured. The particle size of the peak top of the peak present in the distribution was defined as the particle size of strontium titanate particles.

1-7. Preparation of Toner for Electrostatic Charge Image Development

1-7-1. Preparation of Toner (1)

To 100 parts by mass of toner base particles (1), 0.6 parts by mass of hydrophobic silica particles (number average primary particle diameter: 12 nm, degree of hydrophobization: 68), 1.0 parts by mass of strontium titanate particles A1, and 10 parts by mass of sol-gel silica (number average primary particle diameter: 110 nm) were added, and the mixture was mixed by a Henschel mixer (manufactured by Nippon Coke Industry Co., Ltd.) at a rotating blade peripheral speed of 35 mm/sec for 20 minutes at 32° C. After mixing, coarse particles were removed using a 45 μm sieve of eye opening.

To the toner particles thus obtained, a ferrite carrier having a volume average particle diameter of 32 μm coated with an acrylic resin was added and mixed so that the concentration of the toner particles became 6% by mass. Thus, a toner (1), which is a two component developer, was obtained as a toner for developing an electrostatic charge image.

1-7-2. Preparation of Toner (2) to Toner (12)

Toner (2) to toner (12) were prepared in the same manner as in the preparation of the toner (1), except that toner base particles (2) to toner base particles (12) were each used instead toner base particles (1).

1-7-3. Preparation of Toner (13)

Toner (13) was obtained in the same manner as in the preparation of toner (1), except that strontium titanate A was not used and the amount of hydrophobic silica particles was changed to 1.6 parts by mass instead.

Table 1 shows the toner base particles used in the preparation of the toner (1) to the toner (13), the type of the pigment and the amount thereof (the amount of each pigment (parts by mass when the mass of the toner base particles is set to 100 parts by mass)), the type of the resin, and the use of strontium titanate used as an external additive.

TABLE 1

| | Toner Base Particle | | | | | | | | | | | | |
|---|---|---|---|---|---|---|---|---|---|---|---|---|---|
| | | Pigment | | | | | | | | | | | |
| | Base | | Organic Pigments | | | | | | | | Binder resin | | External |
| Toner | Particle | CB | Dispersion | | | | | | | Total | Crystalline | Other | Additive |
| No. | No. | Parts | No. | Name | Parts | Name | Parts | Name | Parts | Parts | Resin | Resin | SrTiO₃ |
| (1) | (1) | 0.5 | P1 | PB15:3 | 6.0 | PV23 | 6.0 | — | — | 12.5 | C1 | s1 + a1 | + |
| (2) | (2) | 0.5 | P1 | PB15:3 | 6.0 | PV23 | 6.0 | — | — | 12.5 | C1 | at | + |
| (3) | (3) | 0.5 | P1 | PB15:3 | 6.0 | PV23 | 6.0 | — | — | 12.5 | C2 | | + |
| (4) | (4) | 0.5 | P1 | PB15:3 | 6.0 | PV23 | 6.0 | — | — | 12.5 | — | a1 | + |
| (5) | (5) | 0.05 | P1 | PB15:3 | 6.0 | PV23 | 6.0 | — | — | 12.1 | Cl | a1 | + |
| (6) | (6) | 2.9 | P1 | PB15:3 | 6.0 | PV23 | 6.0 | — | — | 14.9 | C1 | a1 | + |
| (7) | (7) | 3.0 | P1 | PB15:3 | 6.0 | PV23 | 6.0 | — | — | 15.0 | C1 | a1 | + |
| (8) | (8) | 0.5 | P2 | PB15:3 | 6.0 | PV24 | 6.0 | — | — | 12.5 | C1 | a1 | + |
| (9) | (9) | 0.5 | P3 | PB16 | 6.0 | PV23 | 6.0 | — | — | 12.5 | C1 | a1 | + |
| (10) | (10) | 0.5 | P4 | — | — | — | — | PBr25 | 6.0 | 12.5 | C1 | a1 | + |
| | | | | | | | | PR269 | 6.0 | | | | |
| (11) | (11) | — | P1 | PB15:3 | 6.0 | PV23 | 6.0 | — | — | 12.0 | C1 | a1 | + |
| (12) | (12) | 0.5 | P5 | PB15:3 | 12.0 | — | — | — | — | 12.5 | C1 | a1 | + |
| (13) | (2) | 0.5 | P1 | PB15:3 | 6.0 | PV23 | 6.0 | — | — | 12.5 | C1 | a1 | − |

2. Evaluation

2-1. Image Density

Using a commercially available multifunctional device (manufactured by Konica Minolta Corporation, bizhub PRO C6500), 100 consecutive prints were performed using each of the toner (1) to toner (13) as a black toner and without using the toner of other colors. The images were created under an ambient of 30° C. and 80% RH in relative humidity. The image to be produced by the continuous printing was obtained by outputting, on an A4 size recording material (coated paper), a person facial photograph image, a halftone image having a relative reflection density of 0.4, a white ground image, and a solid image having a relative reflection density of 1.3 in 4 equal parts. Note that the relative reflectance density of the halftone image and the solid image is measured by a reflectance densitometer (manufactured by Macbeth Co., Ltd., RD918). After completion of the 100 successive prints described above, 10 consecutive solid images with 3.0 g/m² amounts of toner adhering were printed.

The image density (absolute density) of the solid pattern of the above 10 prints was measured by a reflectance densitometer (manufactured by X-Rite Co., Ltd., X-Rite model 404), and the image density was evaluated on the basis of the average value of the 10 image densities on the basis of the following criteria.

AA: The average value of the image density is 1.80 or more

A: The average value of the image density is 1.75 or more and less than 1.80

B: The average value of the image density is 1.70 or more and less than 1.75

C: The average value of the image density is less than 1.7

2-2. Low Temperature Fixability

Regarding a fixing device of a commercially available multifunction machine (Konica Minolta Co., Ltd., bizhub PRO C1070), a remodeled device in which surface temperatures of pressure rollers and fixing rollers, toner adhesion amounts, and system speeds were changeable was used. In an ambient temperature and normal humidity (temperature: 20° C., relative humidity: 50% RH), using each of the toner (1) to toner (13) as a black toner and without using the toner of other colors, a solid image having a toner adhering amount of 11.3 g/m and a size of 100 mm×100 mm was formed on a high quality paper of A4 size (manufactured by Nippon Paper Industries Co., Ltd., NPI supernatant (basis weight: 127.9 g/m²). At this time, the image was repeatedly formed up to 180° C. while increasing the temperature of the fixing roller in increments of 2° C. from 110° C. Then, the lowest fixing temperature (U.O. avoidance temperature) was set as the lowest fixing temperature at which image stain due to the fixing offset was not visually confirmed, and the low temperature fixability was evaluated by the following criteria.

AA: The minimum fixing temperature is less than 135° C.

A: The minimum fixing temperature is 135° C. or higher and lower than 140° C.

C: The minimum fixing temperature is 140° C. or higher.

2-3. Charging Rise

Using a commercially available composite machine (manufactured by Konica Minolta Co., Ltd., bizhub PRO C6500), an image was formed on a high quality paper (65 g/m²) of an A4 plate in an environment of a low temperature and low humidity environment (temperature 10° C., relative humidity 20% RH) to form a belt-like solid image having a printing ratio of 5% as a test image 0.1 million. The image density (absolute density) of the 100 and 2000 solid image portions was measured by a reflectance densitometer (manufactured by Macbeth Co., Ltd., RD918), and based on these 2 density differences, the charge rising property was evaluated on the basis of the following criteria.

AA: The concentration difference was less than 0.05

A: The concentration difference was 0.05 or more and less than 0.07

B: The concentration difference was 0.07 or more and less than 0.1

C: The concentration difference was 0.1 or more

2-4. Charging Stability

After 0.1 million sheets of image formation performed in the evaluation of the charge rising property, the inside of the machine was once cleaned. Thereafter, a character image having a printing ratio of 5% was printed on a high-quality paper of A4 size on 10000 sheets, and in addition, 10000 sheets of 10% character image were printed, and then 10000 sheets of 20% character image were printed, and a total of 30000 prints were printed. The amount of toner scattered was defined as the total amount of toner scattered in the main body of the image forming apparatus, the cartridge, and the toner filter there. After printing the 30000 sheets, the toner scattered around the developing portion such as the upper lid of the cartridge was sucked and its mass was measured, and the mass of the toner adhered to the toner filter was measured, and the sum of these was defined as the toner scattering amount (g). Based on the toner scattering amount, the charging stability was evaluated on the basis of the following criteria.

AA: The amount of toner scattering was less than 0.5 g

A: The amount of toner scattering was 0.5 g or more and less than 1.0 g

C: The amount of toner scattering was 1.0 g or more

Table 2 shows the evaluation results of toner (1) to toner (13).

TABLE 2

| | Toner | Image | | Low Temperature | | Charging | | Charging | |
|---|---|---|---|---|---|---|---|---|---|
| | No. | Density | | Fixability | | Rise | | Stability | |
| Working | (1) | AA | (1.85) | AA | (133° C.) | AA | (0.02) | AA | (0.2 g) |
| Example | | | | | | | | | |
| Working | (2) | AA | (1.87) | AA | (132° C.) | AA | (0.03) | AA | (0.4 g) |
| Example | | | | | | | | | |
| Working | (3) | AA | (1.81) | A | (135° C.) | AA | (0.03) | AA | (0.3 g) |
| Example | | | | | | | | | |
| Working | (4) | A | (1.79) | A | (137° C.) | AA | (0.04) | AA | (0.4 g) |
| Example | | | | | | | | | |
| Working | (5) | B | (1.74) | AA | (134° C.) | AA | (0.03) | A | (0.8 g) |
| Example | | | | | | | | | |
| Working | (6) | AA | (1.81) | AA | (133° C.) | B | (0.07) | A | (0.7 g) |
| Example | | | | | | | | | |
| Working | (7) | AA | (1.83) | A | (136° C.) | B | (0.08) | A | (0.6 g) |
| Example | | | | | | | | | |
| Working | (8) | A | (1.77) | AA | (133° C.) | A | (0.05) | A | (0.5 g) |
| Example | | | | | | | | | |
| Working | (9) | A | (1.75) | AA | (134° C.) | A | (0.06) | A | (0.5 g) |
| Example | | | | | | | | | |
| Working | (10) | B | (1.73) | AA | (133° C.) | B | (0.07) | A | (0.6 g) |
| Example | | | | | | | | | |
| Comparative | (11) | A | (1.76) | AA | (132° C.) | A | (0.06) | C | (1.2 g) |
| Example | | | | | | | | | |
| Comparative | (12) | C | (1.69) | AA | (133° C.) | B | (0.08) | A | (0.7 g) |
| Example | | | | | | | | | |
| Comparative | (13) | AA | (1.84) | AA | (133° C.) | C | (0.11) | C | (1.1 g) |
| Example | | | | | | | | | |

As is apparent from Table 2, toner (1) to toner (10) containing a binder resin, a toner base particle containing at least two kinds of organic pigments, and carbon black, and an external additive containing strontium titanate adhering to the surface of the toner base particles, were more stable in charging stability than toner (I1) containing no carbon black, and had a higher image density than toner (12) containing only one kinds of organic pigments, and had a higher charging rise property and a higher charging property than toner (13) containing no strontium titanate.

In addition, toner (1) to toner (9) containing a blue pigment and a violet pigment as the above organic pigment had a higher image density than toner (10) which does not contain these pigments. In particular, when PB15:3 or PB15:4 was contained as a blue pigment and PV23 was contained as a violet pigment, a tendency of higher image density was seen.

In addition, as the content of carbon black was reduced, a tendency was observed in which the charging rise property became better (Toner (5) to Toner (7))

Further, when the toner base particles contained a crystalline resin, low-temperature fixability was improved, and particularly when the crystalline resin was a crystalline polyester, low-temperature fixability became higher.

### INDUSTRIAL APPLICABILITY

According to the present invention, there is provided a toner containing two or more kinds of pigments, which can form an image excellent in various characteristics required at the time of image formation and also excellent in various characteristics required for an image.

Although embodiments of the present invention have been described and illustrated in detail, the disclosed embodiments are made for purposes of illustration and example only and not limitation. The scope of the present invention should be interpreted by terms of the appended claims.

What is claimed is:

1. A toner for electrostatic charge image development comprising:
a toner base particle comprising a binder resin, at least two kinds of organic pigments, and carbon black; and
strontium titanate as an external additive.

2. The toner for electrostatic charge image development according to claim 1, wherein the at least two kinds of organic pigments comprise a blue pigment and a violet pigment.

3. The toner for developing an electrostatic charge image according to claim 2, wherein the blue pigment comprises C.I. Pigment Blue 15:3 or C.I. Pigment Blue 15:4.

4. The toner for developing an electrostatic charge image according to claim 2, wherein the violet pigment comprises C.I. Pigment Violet 23.

5. The toner for developing an electrostatic charge image according to claim 1, wherein the toner base particle contains more than 0.1% by mass and less than 3.0% by mass of the carbon black, based on the total content of the toner base particles and the external additives.

6. The toner for developing an electrostatic charge image according to claim 1, wherein the toner base particle contains more than 0.1% by mass and less than 1.0% by mass of the carbon black, based on the total content of the toner base particles and the external additives.

7. The toner for developing an electrostatic charge image according to claim 1, wherein the binder resin comprises a crystalline resin.

8. The toner for developing an electrostatic charge image according to claim 1, wherein the binder resin comprises a crystalline polyester.

9. An image forming method comprising:
adhering the toner for developing an electrostatic charge image according to claim 1 to a recording medium; and
fixing the adhered toner for developing an electrostatic charge image to the recording medium.
